(19) United States
(12) Patent Application Publication
(10) Pub. No.: US 2025/0346518 A1
(43) Pub. Date: Nov. 13, 2025

(54) COMPOSITE MATERIAL FOR A GLASS MELTING APPARATUS

(71) Applicant: Owens-Brockway Glass Container Inc., Perrysburg, OH (US)

(72) Inventor: Eric Jelen, Waterville, OH (US)

(21) Appl. No.: 18/659,498

(22) Filed: May 9, 2024

(51) Int. Cl. C03B 5/43; C03B 5/235; C03B 5/44; C03C 14/00

(52) U.S. Cl. CPC C03B 5/43; C03B 5/2356; C03B 5/44; C03C 14/002; C03C 14/004; C03C 2214/02; C03C 2214/04; C03C 2214/30

(57) ABSTRACT

A glass melting apparatus, such as a submerged combustion melter, has a housing that includes at least one wall, which may be liquid cooled. The wall includes an inner composite layer that faces an interior chamber of the melting apparatus and, in operation of the apparatus, contacts molten glass. The inner composite layer is comprised of a composite material that includes glass and clay and, additionally, may further include one or more of a refractory material, reinforcing fibers, an adhesion agent, or an atomizing agent. The wall of the housing may be provided by a plurality of panels with each panel providing a portion of the inner composite layer. A method of making the composite material from a castable material, which may be an aqueous slurry that includes water and a solids mixture, is also disclosed.

### TECHNICAL FIELD

This patent application discloses innovations related to glass manufacturing and, more particularly, to materials used to construct a glass melting apparatus.

### BACKGROUND

Glass manufacturing typically involves the use of a furnace or melter to melt incoming batch materials (e.g., silica, soda ash, limestone, cullet, and various minors) to produce molten glass. The melting equipment is conventionally lined with a ceramic refractory liner such as fused cast AZS, which is predominantly composed of one or more of silica, alumina, and zirconia. One potential problem associated with conventional ceramic refractory liners-particularly in submerged combustion melters in which combustion products are fired directly into a glass melt causing turbulence in the melt and significant vibration in the melter is that the liner may sometimes crack or erode over time. Cracking and/or erosion of the refractory liner may result in refractory liner pieces becoming separated from the rest of the material. These foreign refractory liner pieces may survive in molten glass and cause commercial variances or defects, such as “stones,” in the glass products subsequently produced from the molten glass drawn from the furnace or melter. The affected glass products may need to be rejected, recycled, and returned to the furnace or melter as cullet, and the refractory liner may eventually need maintenance or have to be replaced, all of which renders the manufacturing process less efficient.

### SUMMARY OF THE DISCLOSURE

A composite material for a glass melting apparatus is disclosed. The glass melting apparatus has a housing that includes at least one wall such as, for example, a floor or a sidewall that extends upwardly away from the floor, and an inner composite layer that is part of the wall and faces an interior chamber of the housing is comprised of the composite material. The wall may be liquid cooled, particularly if the glass melting apparatus is a submerged combustion melter, and thus may also include a liquid cooled support base adjacent to and outside of the inner composite layer relative to the interior chamber of the housing. Moreover, the wall may be at least partially constructed from a plurality of panels that are coupled together, especially if the wall is liquid cooled and part of a submerged combustion melter. Such a panel includes a base panel substrate and a composite layer substrate carried by the base panel substrate, which, respectively, provide corresponding portions of the liquid cooled support base and the inner composite layer of the wall in which the panel is included. The composite material that comprises the inner composite layer or, in the context of a panel, the composite layer substrate, includes glass and one or more other inorganic non-metallic solid materials. For example, the composite material may include glass, clay, and one or more of a refractory material, reinforcing fibers, an adhesion agent, or an atomizing agent.

### BRIEF DESCRIPTION OF THE DRAWINGS

FIG. 1 is a cross-sectional view of a portion of a glass melting apparatus; and

FIG. 2 is an exploded view of a liquid cooled panel, which includes a composite layer substrate comprised of a composite material, for use in constructing a wall of the glass melting apparatus.

### DETAILED DESCRIPTION

A composite material for use in a glass furnace or glass melter (referred to collectively as a “glass melting apparatus”) is disclosed. The composite material may be employed as a glass-contacting inner composite layer of a wall of the glass melting apparatus and may have a composition that includes a combination of glass and one or more other inorganic non-metallic solid materials such as clay, a refractory material, and/or reinforcing fibers. The wall of the glass melting apparatus, particularly if the apparatus is a submerged combustion melter, may be comprised of a plurality of panels that are coupled together. If, during operation of the glass melting apparatus, a piece of the composite material breaks away or becomes dislodged from the inner composite layer due to any number of reasons, the loose piece of composite material can melt and be integrated into the molten glass contained within the glass melting apparatus. In this way, dislodged foreign pieces of the composite material do not contaminate the molten glass contained in the glass melting apparatus in the way that a conventional piece of a ceramic refractory liner would and may go undetected in subsequently formed glass products.

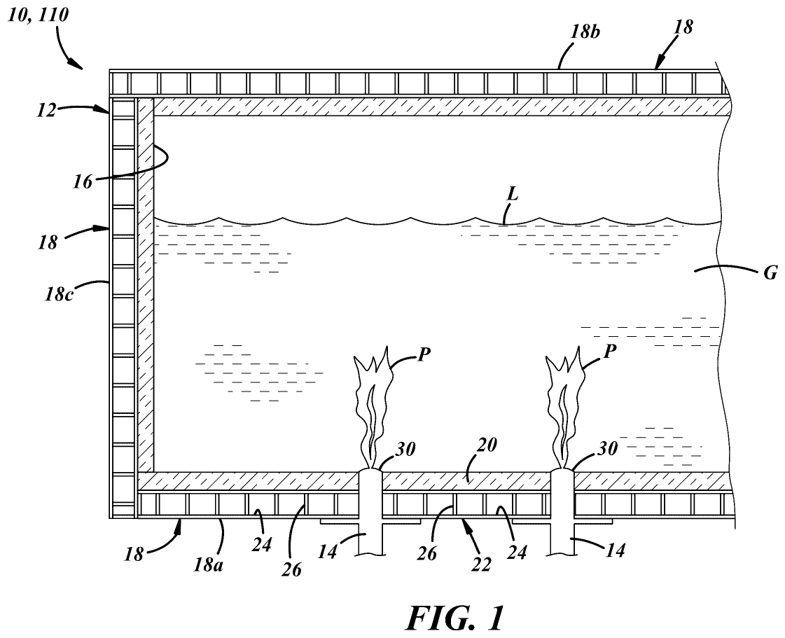

A portion of an industrial glass melting apparatus 10 is illustrated in FIG. 1. The glass melting apparatus 10 shown here is a submerged combustion melter 110. The submerged combustion melter 110 includes a housing 12 and one or more submerged burners 14 received through the housing 12. The housing 12 defines an interior chamber 16 in which a glass melt G is contained and includes at least one wall 18. For example, the wall(s) 18 of the housing 12 may include a floor 18a, a roof 18b opposite the floor 18a, and a sidewall 18c that extends upwardly from the floor 18a between the floor 18a and the roof 18b. The sidewall 18c may contain one or more planar faces that meet at identifiable edges or it may embody a more indivisible shape. Each of the one or more submerged burners 14 is received in and extends through at least one of the walls 18, preferably the floor 18a of the housing 12, and is positioned to fire combustion products P into the interior chamber 16 of the melter 110 through the wall 18 in which the burner 14 is received. The housing 12 provides a batch inlet (not shown) where a batch material is introduced into the interior chamber 16, a molten glass outlet (not shown) where output molten glass is drawn out of the melter 110 from the glass melt G, and an exhaust outlet (not shown).

A discharge end or tip 30 of each of the submerged burners 14 is aimed into the interior chamber 16 of the submerged combustion melter 110. When the submerged combustion melter 110 is operating, the discharge end 30 of each of the submerged burners 14 is submerged in the glass melt G such that a combustible gas mixture supplied to each burner 14 ignites and discharges the resultant combustion products P directly into and through the glass melt G. The discharged combustion products P heat and agitate the glass melt G, which allows the batch material that is introduced into the interior chamber 16 to be melted into molten glass within the glass melt G at a relatively fast rate compared to conventional glass melting approaches. As the batch material is being introduced into the interior chamber 16 and melted, to thus produce more molten glass within the glass melt G, output molten glass is pulled from the glass melt G and drawn out of the melter 110. The output molten glass may then be fined and conditioned-fining is the process of removing bubbles from the glass and conditioning is the process of bringing the glass to the correct viscosity for forming operations-before forming the glass into a glass product such as a glass container. While a submerged combustion melter is shown here in FIG. 1, the glass melting apparatus 10 may, in other embodiments, be a conventional glass furnace that uses overhead burners to supply the radiant heat needed to heat and melt the incoming batch material into molten glass.

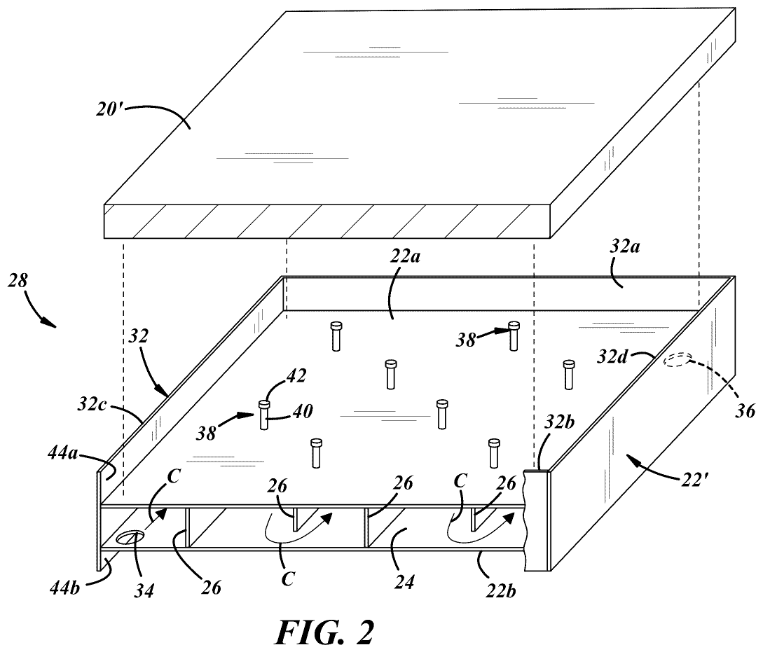

At least one wall 18 of the submerged combustion melter 110 may be liquid cooled with water or another cooling liquid C (FIG. 2). Typically, at the very least, the floor 18a and the sidewall 18c of the housing 12 are liquid cooled since those walls 18 are fully or partially below the nominal surface level L of the glass melt G. The wall 18 includes an inner composite layer 20 that faces the interior chamber 16 of the melter 110 and, if liquid cooled, a liquid cooled support base 22 adjacent to and outside of the inner composite layer 20 relative to the interior chamber 16. The inner composite layer 20 contacts the glass melt G in the submerged combustion melter 110 when the melter 110 is operating and may be comprised of the composite material. The term “contact” is used broadly here and encompasses direct contact as well as indirect contact in which a layer of solidified or frozen glass—this layer forms in-situ over the surface of the inner composite layer 20 when molten glass contacts and loses heat to the liquid cooled wall 18—is disposed between the molten glass of the glass melt G and the inner composite layer 20. The liquid cooled support base 22 is a structural subwall that provides structural integrity to the wall 18 and defines one or more internal cooling channels 24 through which the cooling liquid C, for example, water, may circulate along a flow path as directed by internal partitions or baffles 26 to cool the wall 18. The inner composite layer 20 may of course be employed as part of a wall that is not liquid cooled as well.

While not shown explicitly in FIG. 1, each wall 18 of the melter 110 may be at least partially constructed from a plurality of individual panels coupled together side-by-side as an array of panels. Such a panel 28 is shown in FIG. 2 with its associated portions 20′, 22′ of the inner composite layer 20 and the liquid cooled support base 22 shown separated from each other. These portions 20′, 22′ of the inner composite layer 20 and the liquid cooled support base 22 as provided by each of the plurality of panels 28 are referred to herein as the composite layer substrate (reference numeral 20′) and the base panel substrate (reference numeral 22′); in other words, when the plurality of panels 28 are coupled together to provide the liquid cooled wall 18, the composite layer substrates 20′ and the base panel substrates 22′ of the panels 28 cooperate to establish the inner composite layer 20 and the liquid cooled support base 22, respectively, of the constructed liquid cooled wall 18. Here, each base panel substrate 22′ defines one cooling channel 24 such that each of the base panel substrates 22′ that together constitute the liquid cooled support base 22 of the liquid cooled wall 18 are individually and separately cooled with a circulating flow of the cooling liquid C.

The base panel substrate 22′ includes first and second opposed plates 22a, 22b that are spaced apart from each other, with the cooling channel 24 being defined therebetween, as well as one or more partitions 26 between the plates 22a, 22b to establish the flow path of the cooling channel 24. The base panel substrate 22′ also includes a frame 32, preferably rectangular in shape, which circumscribes the first and second opposed plates 22a, 22b and may circumscribe the composite layer substrate 20′ that is carried by the base panel substrate 22′. The first and second plates 22a, 22b and the frame 32 together define the cooling channel 24. The frame 32 may be unitary or it may be comprised of several edge panels 32a-32d with each edge panel 32a-32d enclosing one side of the base panel substrate 22′. One edge panel 32b of the frame 32 is partially omitted in FIG. 2 to reveal the partitions 26 of the base panel substrate 22′, which are arranged so that a circulating flow of the cooling liquid C flows from a coolant inlet 34 at one corner of the base panel substrate 22′, through the cooling channel 24 along a serpentine flow path, and eventually to a coolant outlet 36 at another corner of the base panel substrate 22′. The coolant inlet 34 and the coolant outlet 36 may each be defined in one of the opposed plates 22a, 22b, or the frame 32, and do not necessarily have to be located at opposite corners of the base panel substrate 22′ or in any particular plate 22a, 22b or portion of the frame 32.

The frame 32 defines the outer perimeter of the cooling channel 24 of the base panel substrate 22′ and may extend away from the cooling channel 24 in opposite directions to at least partly define first and second flanges 44a, 44b, respectively, that extend from the first and second plates 22a, 22b of the base panel substrate 22′. The frame 32 may provide beam-like structural stiffness to the base panel substrate 22′ and thus the panel 28 and the portion of the liquid cooled wall 12 provided by the panel 28. The first flange 44a circumscribes the composite layer substrate 20′ carried by the base panel substrate 22′, and the second flange 44b may provide attachment points (e.g., fastener openings or weld locales) for coupling the panel 28 to one or more adjacent panels 28. The first flange 44a may also function as a mold for the composite layer substrate 20′ when the composite material that comprises the composite layer substrate 20′ is formed as described in more detail below. The opposed first and second plates 22a, 22b, the partitions 26, and the frame 32 may be constructed of a metal, such as steel, or any other suitable material.

The base panel substrate 22′ may also include one or more inner layer retention features 38 that retain the composite layer substrate 20′ to first plate 22a. The retention features 38 may be protrusions that extend away from the first plate 22b such that, in the constructed panel 28, the protrusions are at least partially embedded in the composite layer substrate 20′. Each of the protrusions, for example, may include a post 40 that extends from the first plate 22a to an optional enlarged head 42 at a distal end of the post 40. The retention features 38 help retain the composite layer substrate 20′ to the base panel substrate 22′ as the composite material that comprises of the composite layer substrate 20′ may experience shrinkage or other dimensional changes during formation. The retention features 38 may take other forms and/or extend from other portions of the base panel substrate 22′ but preferably are embedded into the composite layer substrate 20′ to form an interlocking condition with the composite layer substrate 20′. While a specific example of the panel 28 has been illustrated and described here, the panel 28 may of course be constructed differently. For example, the panel 28 may include additional structural components within the base panel substrate 22′, one or both of the first and second flanges 44a, 44b may be omitted, one or both of the first and second flanges 44a, 44b may be formed from different pieces of material than the rest of the frame 32 and then attached in place, and/or the composite layer substrate 20′ may be formed separate and apart from the base panel substrate 22′ and later fitted onto the base panel substrate 22′.

The composite material from which the inner composite layer 20 is formed includes glass and at least one of the following inorganic non-metallic solid materials: a refractory material, clay, or reinforcing fibers. Accordingly, if the inner composite layer 20 of the liquid cooled wall 18 of the submerged combustion melter 110 is provided by the composite layer substrates 20′ of multiple panels 28, the same composite material is used to form the composite layer substrate 20′ of each panel 28 and, thus, the discussion of the composition of the composite material applies equally to the inner composite layer 20 and the composite layer substrate 20′. The composite material may be formed from a castable material that is deposited by a trowel, through spraying, or by some other deposition technique followed by hardening the castable material into the composite material. Additional details relating to preparing, depositing, and hardening the castable material into the composite material are provided below.

The glass included in the composite material may be soda-lime-silica glass or a combination of soda-lime-silica glass and non-soda-lime-silica glass, which may include varying amounts of B₂O₃, Li₂O, MgO, Na₂O, and/or CaO, and is preferably present in combination with clay and a refractory material. Soda-lime-silica glass has a glass chemical composition that includes 60 wt % to 80 wt % SiO₂, 8 wt % to 18 wt % Na₂O, and 5 wt % to 15 wt % CaO, plus other constituents, based on the total weight of the glass. In addition to the oxide constituents just mentioned, soda-lime-silica glass often includes between 0.3 wt % and 3 wt % Al₂O₃ as well. Should a piece of the composite material break away from the inner composite layer 20 and make its way into the glass melt G when the submerged combustion melter 110 is operating, the glass component of the dislodged piece of composite material can easily melt into molten glass within the glass melt G. This glass chemical compatibility helps minimize or altogether prevent the possibility that the dislodged piece of the composite material will cause stones or other commercial variances in glass products that are subsequently formed from output molten glass that is drawn from the submerged combustion melter 110.

The composite material includes at least 20 wt % glass. For example, the composite material may include 20 wt % to 95 wt % of glass or, more narrowly, may include 20 wt % to 70 wt % of glass, 20 wt % to 60 wt % of glass, 40 wt % to 70 wt % of glass, 20 wt % to 30 wt % of glass, 40 wt % to 50 wt % of glass, or 60 wt % to 70 wt % of glass. The glass is preferably cullet (i.e., recycled glass) that may be internally sourced from glass product manufacturing operations or externally sourced from cullet suppliers, glass recycling facilities, or some other source of recycled glass. The glass may be milled, crushed, powered, or otherwise broken down into relatively small glass particles having particles sizes in the largest dimension that range, for example, from 1 μm to 2.5 cm, although smaller and larger particle sizes may be employed. Though not required, it may be preferred that the glass is provided as glass particles having a particle size of 100 μm or less, or more narrowly a particle size of 50 μm or less such as a 325-mesh particle size (325M), particularly in applications where the process of forming the composite material involves spray depositing the castable material. These smaller particle sizes may also help the glass particles melt faster should a piece of the composite material break off from the inner composite layer 20 and enter the glass melt G.

The refractory material (or “refractory”) may be silica, a silicate, alumina, or a mixture thereof. Silica has the chemical formula SiO₂ and alumina, which may be synthetic (e.g., derived from bauxite) or naturally-occurring (corundum), has the chemical formula Al₂O₃. The silicate may be zircon, which has the chemical formula ZrSO₄, or an aluminosilicate such as feldspar or a ceramized refractory clay such as burnt clay or fire clay. The refractory may be included in the composite material, preferably as particles, to provide the composite material with refractory properties or to increase the refractoriness of the composite material—i.e., to increase its heat resistance relative to other ingredients of the composite. The composite material may include up to 75 wt % of the refractory or, more narrowly, 1 wt % to 75 wt % of the refractory, 15 wt % to 65 wt % of the refractory, 20 wt % to 60 wt % of the refractory, 15 wt % to 25 wt % of the refractory, 35 wt % to 45 wt % of the refractory, or 55 wt % to 65 wt % of the refractory.

The refractory material, if included in the composite material, is less liable to survive in molten glass and thereafter produce commercial variances in subsequently formed glass products for several reasons. First, the glass and other potential components of the composite material reduce or dilute the refractory content of the composite material compared to traditional ceramic refractory liners. Second, the refractories included in the composite material have relatively low melting points and, thus, can melt more readily in molten glass. Silica, which is the preferred material included in the composite material, as well as alumina and feldspar are all commonly included in the batch material anyway, which means the glass melting process is already designed to melt such materials. And third, the particle size of the refractory material included in the composite material may be chosen to help promote melting in molten glass, especially for higher melting point materials like zircon and burnt and fire clays. A preferred particle size in the largest dimension that is suitable for such a purpose is 50 μm or less including, for example, a 325-mesh particle size.

The clay may be provided in the composite material for multiple purposes and may be a single clay or a combination of clays. Several types of clays that may be included in the composite material are described below and, in preferred applications of the composite material, the clay(s) are phyllosilicates, which are sheet silicates such as kaolinite clays, smectite clays, and mica clays. Several phyllosilicate clays may be used in combination to tailor the properties of the composite material and the castable material from which the composite material is formed. In general, however, the clay acts as a binder material for the other components of the composite material, particularly during initial formation of the composite material from the castable material as will be described in further detail below. The composite material may include 2 wt % to 25 wt % of the clay in total or, more narrowly, 5 wt % to 18 wt % of the clay in total or 8 wt % to 15 wt % of the clay in total. The clay(s) are preferably particles when added to the castable material that have a particle size in the largest dimension of 100 μm or less such as a 200-mesh particle size or, more narrowly, 50 μm or less such as a 325-mesh particle size, although larger and/or smaller particle sizes are feasible.

The composite material may include one or more kaolinite clays such as, for example, one or more ball clays. A kaolinite clay is any clay that includes kaolinite, which is a hydrated aluminum silicate having the chemical formula Al₂Si₂O₅(OH)₄, as its largest compositional constituent or any clay in which kaolinite is the only clay mineral present. Ball clays are naturally occurring kaolinite clays that include kaolinite and possibly other minerals as well. Some other minerals that may be found in a ball clay include quartz (crystalline silica) and/or mica. One illustrative ball clay that may be present in the composite material includes 60 wt % to 90 wt % kaolinite and 10 wt % to 30 wt % silica. Such a ball clay is commercially available from Imerys Ceramics under the designation OM4 clay. The kaolinite clay, if present, may constitute 45 wt % to 100 wt % of the total clay included in the composite material; that is, the clay portion of the composite material may contain only a kaolinite clay (100% of the clay portion) or the clay portion may include at least 45 wt % of the kaolinite clay if the composite material includes more than one different clay. In one embodiment, and based on the total weight of the composite material, the composite material may include 2 wt % to 25 wt % or, more narrowly, 2 wt % to 20 wt % or even 5 wt % to 13 wt %, of kaolinite clay regardless if any other clays are present.

The composite material may also include one or more smectite clays such as, for example, one or more bentonite clays or magnesium aluminum silicate clays. A smectite clay is a swelling clay that includes montmorillonite or saponite as its largest compositional constituent or any clay in which montmorillonite or saponite is the only clay mineral present. Smectite clays expand more than kaolinite clays in water. Bentonite clays are smectite clays having montmorillonite as its largest constituent that are typically charged balanced by either sodium or calcium and, thus, are categorized as a sodium bentonite clay or a calcium bentonite clay. Magnesium aluminum silicate clays are smectite clays that include magnesium, aluminum, silicon, and oxygen as the main chemical elements and often include a mixture of montmorillonite and saponite or are purified and chemically modified bentonite clay. The smectite clay, if present, may constitute from 1 wt % to 55 wt % or, more narrowly, from 1 wt % to 45 wt % of the total clay included in the composite material; that is, the clay portion of the composite material may include between 1 wt % and 55 wt % of the smectite clay if the composite material includes more than one different clay. In one embodiment, and based on the total weight of the composite material, the composite material may include up to 4 wt % or, more narrowly, 0.5 wt % to 3 wt %, of smectite clay.

Both a bentonite clay and a magnesium aluminum silicate clay may be included in the composite material as a smectite clay. While both the sodium and calcium charged bentonite clays are suitable, sodium bentonite clay may be preferred over calcium bentonite due to its greater swelling capacity, which, in turn, may provide the kaolinite clay with better plasticity. One particular bentonite clay that may be used is available from Laguna Clay Company under the designation VOLCLAY® 325. Magnesium aluminum silicate clays have somewhat different properties than bentonite clays and can therefore influence different properties of the composite material and the castable material from which the composite material is formed. One particular magnesium aluminum silicate clay that may be used is available from Vanderbilt Minerals under the designation VEEGUM® T. When both types of smectite clay are present, the ratio of the weight percent of magnesium aluminum silicate clay to the weight percent of bentonite clay in the composite material may range from 10:1 to 2:1 or, more narrowly, from to 5:1 to 3:1.

As part of a castable material, the clay retains water to provide malleability to the castable material, which permits the castable material to be shaped. The high viscosity of the clay also helps maintain the non-clay solid materials in suspension such that the castable material and the composite material formed therefrom are well dispersed and do not settle into a concentrated solids layer. Moreover, as previously mentioned, utilizing a combination of multiple phyllosilicate clays can help tailor the properties of the castable material and the composite material formed therefrom. Specifically, the kaolinite clay and, in particular, ball clay, provides the castable material with the majority of the clay-like properties described above, while also promoting suspension of the glass and/or refractory material as well as other non-clay solid materials, high viscosity, high green body strength, as ease of application. Smectite clays expand more than kaolinite clays in water and are thus good suspension agents to help keep the other non-clay solid materials of the castable material suspended. Indeed, when used in combination with a kaolinitic clay, a smectite clay can increase the plasticity, viscosity, and/or adhesiveness (i.e., stickiness) of the castable material. The inclusion of both a bentonite clay and a magnesium aluminum silicate clay in the composite material can help achieve a desirable balance of adhesion, viscosity, plasticity, and strength of the composite material while also helping make the composite material easier to fabricate.

The reinforcing fibers may be included in the composite material to structurally fortify the composite material and to aid in the fabrication of the composite material. The composite material may include up to 10 wt % reinforcing fibers or, more narrowly, 1 wt % to 10 wt %, 1 wt % to 8 wt %, or even 2 wt % to 6 wt %, of the reinforcing fibers. The reinforcing fibers preferably have a diameter ranging from 4 μm to 30 μm and a length ranging from 3 mm to 15 mm, although fibers with larger or smaller diameters, lengths, and aspect ratios may be employed. The reinforcing fibers may be chopped fibers that are not continuous through the composite material. The reinforcing fibers are preferably made from glass—a variety of glass fibers are commercially available from Owens Corning—since glass fibers are more likely to melt in molten glass than other types of fibers should a piece of the composite material break away from the inner composite layer 20 and make its way into the glass melt G when the submerged combustion melter 110 is operating. As for their effect on the castable material, the reinforcing fibers can increase green body strength of the castable material, reduce shrinkage of the castable material during hardening, and/or reduce or prevent cracking of the castable material during hardening. In instances in which the castable material is spray deposited, it may be desirable to limit the length of the reinforcing fibers to no more than 13 mm (i.e., the length of the fibers is 13 mm or less).

The composite material may also include other materials in addition to or in lieu of the materials mentioned above. The composite material may, for example, include an adhesion agent. The adhesion agent increases the adhesiveness of the castable material and may also be selected to increase the viscosity of the castable material and/or to help keep the glass and other non-clay solid materials suspended. The adhesion agent may be gum arabic or cellulose gum (carboxymethyl cellulose, or CMC) and, in some instances, may be included in combination with or as a replacement for all or a portion of the magnesium aluminum silicate clay. The composite material may include up to 2 wt % or, more narrowly, up to 1 wt %, of the adhesion agent. Still further, the composite material may include one or more atomizing agents, which, if present, are typically included to promote atomization of the castable material during spray deposition applications. The atomizing agent may include one or both of magnesium carbonate light (i.e., a basic hydrated magnesium carbonate also referred to as magnesium hydroxide carbonate light) and colloidal silica. The composite material may include 0.125 wt % to 1 wt % of the atomizing agent. Lastly, the composite material may be characterized by the absence or lack of one or more materials. The composite material may, for instance, be free from at least one of, and preferably all of, sodium silicate, alumina, magnesia, and zirconia.

One specific embodiment of the composite material may include 20 wt % to 95 wt % glass in the form of soda-lime silica glass and 2 wt % to 25 wt % of at least one kaolinite clay such as ball clay. Another specific embodiment of the composite material may include 20 wt % to 95 wt % glass in the form of soda-lime silica glass and 2 wt % to 25 wt % of at least one kaolinite clay such as ball clay, and may additionally include a refractory material, at least one smectite clay, and reinforcing fibers such as up to 75 wt % of particles of silica, a silicate, alumina, or a mixture thereof, up to 4 wt % of a bentonite clay and/or a magnesium aluminum silicate clay, and up to 10 wt % chopped glass fibers, respectively. In still other embodiments, the composite material may include: (i) 20 wt % to 95 wt % glass, (ii) 1 wt % to 75 wt % of a refractory material, (iii) 2 wt % to 25 wt % clay, (iv) 1 wt % to 10 wt % of reinforcing fibers, and optionally (v) 0.125 wt % to 1 wt % of an atomizing agent. In these embodiments, the refractory material may be silica, the clay may be 2 wt % to 20 wt % kaolinite clay and 0.5 wt % to 3 wt % smectite clay, the reinforcing fibers may be chopped glass, and the optional atomizing agent may be magnesium carbonate light (Mg₅(CO₃)₄(OH)₂·4H₂O). Additional details of these more specific embodiments of the composite material are included below in Table 1.

TABLE 1
Weight Percent Ranges of Certain
Composite Material Embodiments

| | Example 1 | Example 2 | Example 3 |
|---|---|---|---|
| Material | (wt %) | (wt %) | (wt %) |
| Glass | 65-67 | 44-46 | 24-26 |
| Silica | 20-22 | 40-42 | 61-63 |
| Chopped Glass | 3-5 | 3-5 | 3-5 |
| Ball Clay | 7-9 | 7-9 | 7-9 |
| Bentonite Clay | 0.2-0.3 | 0.2-0.3 | 0.2-0.3 |
| MAS* Clay | 0.7-0.9 | 0.7-0.9 | 0.7-0.9 |
| Magnesium Carbonate Light | 0.3-0.4 | 0.3-0.4 | 0.3-0.4 |

*MAS is an abbreviation for magnesium aluminum silicate

As discussed above, the composite material may be formed from a castable material. The castable material may be an aqueous slurry that includes water and a dispersed solids mixture. The solids mixture generally has the same composition as the composite material except that, in some instances, the solids mixture of the castable material may include an organic material that will volatilize out of the castable material during hardening and/or out of the composite material when heated during use in the glass melting apparatus 10. For example, an organic adhesion agent may be included in the castable material but may not be present to more than a negligible amount in the composite material formed from the castable material. To that end, and for simplicity, volatile organic materials have been disregarded in the description of the solids mixture such that the amount of each material in the composite material is the same as the amount of the same material in the solids mixture of the castable material. As for the amount of water included in the castable material, the water content should be sufficient to make a cohesive slurry that is sufficiently viscous to hold its shape once deposited and sufficiently inviscid to provide formability to the desired shape. Typically, the castable material will include 15 wt % to 45 wt % or, more narrowly, 20 wt % to 35 wt % water, with the remainder of the castable material being the solids mixture.

The castable material is prepared by stirring or otherwise dispersing the solids mixture in water to form the aqueous slurry. For example, a solids mixture that includes (i) 20 wt % to 95 wt % glass, (ii) 1 wt % to 75 wt % of a refractory material, (iii) 2 wt % to 25 wt % clay, (iv) 1 wt % to 10 wt % of reinforcing fibers, and optionally (v) 0.125 wt % to 1 wt % of an atomizing agent, with the specific materials being described above, may be dispersed in water to form the aqueous slurry of the desired consistency and viscosity. The castable material may then be deposited onto a deposition backing, which, for example, may be the first plate 22a of the base panel substrate 22′ or the liquid cooled support base 22 of the wall 18 of the submerged combustion melter 110 depending on the manner in which the inner composite layer 20 is formed. To that end, the castable material may be applied to the first plate 22a of the base panel substrate 22′ as part of a process for fabricating the composite layer substrate 20′ of the panel 28, or the castable material may be applied to the liquid cooled support base 22 of an already-constructed liquid cooled wall 18 of the submerged combustion melter 110. The castable material may be applied by a trowel, through spraying, or by some other deposition technique. The applied layer of castable material may have a thickness that ranges from 25 mm to 50 mm.

After being applied, the deposited castable material is hardened to form the composite material. Hardening of the castable material involves evaporating the water out of the castable material and leaving behind the solids mixture as the composite material. Evaporating the water out of the castable material may be performed by exposing the castable material to the ambient environment or, to accelerate the rate of evaporation, by additionally directing a flow of air on or over the castable material or by heating the castable material. The castable material may be hardened in stages. For instance, the castable material may be dried in air at room temperature (20° C. to 25° C.) for at least 24 hours or, more narrowly, for between 24 hours and 72 hours, which drives off enough water that the resultant dried castable material exhibits a sufficient green strength and is not wet to the touch. The dried castable material may then be heated to a temperature above room temperature to drive all remaining water out of the castable material to produce the composite material. In some cases, the dried castable material may be heated to a temperature at which the glass softens or melts to cause the composite material to become more cohesive and experience better adherence to the surface on which it is applied. Such heating may involve heating the dried castable material to a temperature between 1100° C. and 1300° C. until the glass softens or melts, which also drives all remaining water out of the castable material to produce the composite material, followed by cooling the composite material.

The subject matter of this application is presently disclosed in conjunction with several illustrative embodiments and modifications to those embodiments. All terms used herein are intended to be merely descriptive, rather than necessarily limiting, and are to be interpreted and construed in accordance with their ordinary and customary meaning in the art, unless used in a context that requires a different interpretation. As such, many other embodiments, modifications, and equivalents thereto will readily be suggested to persons of ordinary skill in the art in view of the present disclosure and all such variations, even though not necessarily explicitly disclosed, that fall within the scope of the accompanying claims are intended to be embraced by the present disclosure

1. A glass melting apparatus comprising:
a housing defining an interior chamber and including at least one wall, the wall comprising an inner composite layer that faces the interior chamber and is comprised of a composite material, wherein the composite material comprises at least 20 wt % glass and 2 wt % to 25 wt % of clay.

2. The glass melting apparatus set forth in claim 1, wherein the composite material further comprises up to 75 wt % of a refractory material.

3. The glass melting apparatus set forth in claim 1, wherein the glass includes soda-lime-silica glass and the clay includes one or more phyllosilicate clays.

4. The glass melting apparatus set forth claim 3, wherein the one or more phyllosilicate clays includes a combination of at least one kaolinite clay and at least one smectite clay.

5. The glass melting apparatus set forth claim 1, wherein the composite material further comprises up to 10 wt % of reinforcing fibers.

6. The glass melting apparatus set forth in claim 1, wherein the composite material comprises 20 wt % to 95 wt % glass, 1 wt % to 75 wt % of a refractory material, 2 wt % to 25 wt % clay, and 1 wt % to 10 wt % of reinforcing fibers.

7. The glass melting apparatus set forth in claim 6, wherein the composite material further comprises 0.125 wt % to 1 wt % of an atomizing agent.

8. The glass melting apparatus set forth in claim 1, wherein the glass melting apparatus is a submerged combustion melter that further comprises one or more submerged burners received through the housing.

9. The glass melting apparatus set forth in claim 8, wherein the wall is liquid cooled and further includes a liquid cooled support base adjacent to and outside of the inner composite layer relative to the interior chamber.

10. The glass melting apparatus set forth in claim 9, wherein the wall is at least partially constructed from a plurality of panels, each panel providing a portion of the liquid cooled support base and the inner composite layer of the wall.

11. A submerged combustion melter comprising:
a housing that defines an interior chamber of the submerged combustion melter; and
one or more submerged burners received through the housing, each of the one or more submerged burners having a discharge end that is aimed into the interior chamber;
wherein the housing comprises at least one wall that includes an inner composite layer facing the interior chamber and a liquid cooled support base adjacent to and outside of the inner composite layer relative to the interior chamber, the inner composite layer being comprised of a composite material that comprises at least 20 wt % glass and 2 wt % to 25 wt % of clay.

12. The submerged combustion melter set forth in claim 11, wherein the composite material further comprises at least one of the refractory material, reinforcing fibers, or both a refractory material and reinforcing fibers.

13. The submerged combustion melter set forth in claim 11, wherein the glass includes soda-lime-silica glass and the clay includes one or more phyllosilicate clays.

14. The submerged combustion melter set forth claim 13, wherein the one or more phyllosilicate clays includes a combination of at least one kaolinite clay and at least one smectite clay.

15. The submerged combustion melter set forth in claim 14, wherein the at least one kaolinite clay includes ball clay and the at least one smectite clay includes a bentonite clay and a magnesium aluminum silicate clay.

16. The submerged combustion melter set forth in claim 11, wherein the composite material further 1 wt % to 75 wt % of a refractory material and 1 wt % to 10 wt % of reinforcing fibers.

17. The submerged combustion melter set forth in claim 16, wherein the refractory material includes silica particles.

18. The submerged combustion melter set forth in claim 16, wherein the reinforcing fibers include chopped glass fibers.

19. The submerged combustion melter set forth in claim 11, wherein the composite material comprises: (i) 20 wt % to 95 wt % glass; (ii) 1 wt % to 75 wt % of particles of silica, a silicate, alumina, or a mixture thereof; (iii) 2 wt % to 25 wt % of clay, wherein the clay includes a combination of ball clay, bentonite clay, and a magnesium aluminum silicate clay; (iv) 1 wt % to 10 wt % of chopped glass fibers; and (v) 0.125 wt % to 1 wt % of magnesium carbonate light, colloidal silica, or a mixture thereof.

20. The submerged combustion melter set forth in claim 11, wherein the wall is at least partially constructed from a plurality of panels that are coupled together, each panel providing a portion of the liquid cooled support base and the inner composite layer of the wall.

21. A panel for a liquid cooled wall of a housing of a submerged combustion melter, the panel comprising:
a base panel substrate that includes opposed first and second plates between which a cooling channel of the panel is defined; and
a composite layer substrate carried by the base panel substrate, the composite layer substrate being comprised of a composite material that comprises at least 20 wt % glass and 2 wt % to 25 wt % of clay.

22. The panel set forth in claim 21, further comprising one or more partitions between the plates to establish the flow path of the cooling channel.

23. The panel set forth in claim 21, further comprising one or more inner layer retention features that are at least partially embedded in the composite layer substrate to retain the composite layer substrate.

24. The panel set forth in claim 21, wherein the composite material further comprises at least one of a refractory material, reinforcing fibers, or both a refractory material and reinforcing fibers.

25. The panel set forth in claim 21, wherein the glass includes soda-lime-silica glass and the clay includes one or more phyllosilicate clays.

26. The panel set forth claim 25, wherein the one or more phyllosilicate clays includes a combination of at least one kaolinite clay and at least one smectite clay.

27. The panel set forth in claim 26, wherein the at least one kaolinite clay includes ball clay and the at least one smectite clay includes a bentonite clay and a magnesium aluminum silicate clay.

28. The panel set forth in claim 21, wherein the composite material further 1 wt % to 75 wt % of a refractory material and 1 wt % to 10 wt % of reinforcing fibers.

29. The panel set forth in claim 28, wherein the refractory material includes silica particles.

30. The panel set forth in claim 28, wherein the reinforcing fibers include chopped glass fibers.

31. The panel set forth in claim 21, wherein the composite material comprises: (i) 20 wt % to 95 wt % glass; (ii) 1 wt % to 75 wt % of particles of silica, a silicate, alumina, or a mixture thereof; (iii) 2 wt % to 25 wt % of clay, wherein the clay includes a combination of ball clay, bentonite clay, and a magnesium aluminum silicate clay; (iv) 1 wt % to 10 wt % of chopped glass fibers; and (v) 0.125 wt % to 1 wt % of magnesium carbonate light, colloidal silica, or a mixture thereof.

32. A method of making a composite material for use in a glass melting apparatus, the method comprising:
preparing a castable material in the form of an aqueous slurry that includes water and a solids mixture, the solids mixture comprising at least 20 wt % glass and 2 wt % to 25 wt % of clay;
depositing the castable material onto a deposition backing;
hardening the castable material into a composite material by evaporating the water out of the castable material.

33. The method set forth in claim 32, wherein the solids mixture further comprises at least one of a refractory material, reinforcing fibers, or both a refractory material and reinforcing fibers.

34. The method set forth in claim 32, wherein the solids mixture comprises: (i) 20 wt % to 95 wt % glass; (ii) 1 wt % to 75 wt % of particles of silica, a silicate, alumina, or a mixture thereof; (iii) 2 wt % to 25 wt % of clay, wherein the clay includes a combination of ball clay, bentonite clay, and a magnesium aluminum silicate clay; (iv) 1 wt % to 10 wt % of chopped glass fibers; and (v) 0.125 wt % to 1 wt % of magnesium carbonate light, colloidal silica, or a mixture thereof.

35. The method set forth in claim 32, wherein the deposition backing is a panel that includes a base panel substrate having opposed first and second plates between which a cooling channel of the panel is defined.
